(19) United States
(12) Patent Application Publication
(10) Pub. No.: US 2026/0332360 A1
(43) Pub. Date: Oct. 22, 2026

(54) DEMODULATION REFERENCE SIGNALS (DMRS) BUNDLING IN NON-TERRESTRIAL NETWORKS (NTN)

(71) Applicant: Apple Inc., Cupertino, CA (US)

(72) Inventors: Haitong SUN, Cupertino, CA (US); Chunxuan YE, San Diego, CA (US); Dawei ZHANG, Saratoga, CA (US); Wei ZENG, Saratoga, CA (US); Hong HE, San Jose, CA (US); Chunhai YAO, Beijing (CN); Jie CUI, San Jose, CA (US); Idan BAR-SADE, Sunnyvale, CA (US); Ajay PANCHAL, Cupertino, CA (US); Ankit BHAMRI, Bad Nauheim (DE)

(73) Assignee: Apple Inc., Cupertino, CA (US)

(21) Appl. No.: 19/113,323

(22) PCT Filed: Sep. 29, 2022
(86) PCT No.: PCT/CN2022/122678

§ 371 Date: Mar. 19, 2025

(51) Int. Cl. H04L 5/00; H04W 72/0446; H04W 72/21; H04W 72/51; H04W 84/06

(52) U.S. Cl. CPC H04L 5/0094; H04L 5/0096; H04W 72/0446; H04W 72/21; H04W 72/51; H04W 84/06

(57) ABSTRACT

Approaches are described to provide an indication of demodulation reference signal (DMRS) bundling size for use with non-terrestrial networks (e.g., satellites) in next generation wireless communication networks. These approaches address the changing timing advance (TA) due to the rapid movement of satellites. One approach describes the procedure for a dynamic indication of the DRMS bundling size. In this approach, the network receives an actual time domain window (TDW) size from the user equipment (UE), and performs joint channel estimation based on the UE-indicated TDW. In another approach, the procedure provides a semi-static indication of the DRMS bundling size based on a received UE capability report on TDW duration and an uplink segmentation duration.

### BACKGROUND

### Field

Various aspects generally may relate to the field of wireless communications.

### SUMMARY

Aspects of the approach described herein include a method by a user equipment (UE) for providing a dynamic indication of demodulation reference signal (DMRS) bundling size in a wireless communication network having a satellite. The method includes receiving, from the wireless communication network, a maximum allowed timing advance (TA) variation for DMRS bundling, and also includes reporting, to the wireless communication network, a time domain window (TDW) duration capability. The method further includes receiving, from the wireless communication network, a configured grant for a Physical Uplink Shared Channel (PUSCH), the configured grant indicating the DMRS bundling size, as well as determining an actual TDW size for PUSCH DMRS bundling based on an estimated TA variation compared with the maximum allowed TA variation. The method also includes reporting, to the wireless communication network, the actual TDW size for PUSCH DMRS bundling using the PUSCH channel.

Aspects of the approach described herein also include a method by a wireless communications network for providing a dynamic indication of demodulation reference signal (DMRS) bundling size to a user equipment (UE), the wireless communication network having a satellite. The method includes determining, by the wireless communication network, a maximum allowed timing advance (TA) variation for DMRS bundling, and also receiving, by the wireless communication network, a time domain window (TDW) duration capability from the UE. The method further includes scheduling, by the wireless communication network, a configured grant for a PUSCH channel for the UE, the configured grant indicating the DMRS bundling size, and the DMRS bundling size is based on the TDW duration capability of the UE, as well as receiving, from the UE, an actual TDW size for PUSCH DMRS bundling. The method also includes performing joint channel estimation based on the actual TDW size for PUSCH DMRS bundling.

Aspects of the approach described herein include a user equipment (UE) that includes a radio frequency (RF) transceiver having an antenna, and processing circuitry coupled to the RF transceiver. The RF transceiver is configured to receive, from the wireless communication network, a maximum allowed timing advance (TA) variation for DMRS bundling, and to transmit, to the wireless communication network, a time domain window (TDW) duration capability. The RF transceiver is further configured to receive, from the wireless communication network, a configured grant for a PUSCH channel, the configured grant indicating the DMRS bundling size. The processing circuitry is configured to determine an actual TDW size for PUSCH DMRS bundling based on an estimated TA variation compared with the maximum allowed TA variation. The RF transceiver is further configured to report, via the antenna, to the wireless communication network, the actual TDW size for PUSCH DMRS bundling using the PUSCH channel.

Aspects of the approach include a method by a user equipment (UE) for providing a semi-static indication of demodulation reference signal (DMRS) bundling size in a wireless communication network having a satellite. The method includes receiving, from the wireless communication network, an uplink segmented transmission duration for DMRS bundling, as well as reporting, to the wireless communication network, a time domain window (TDW) duration capability. The method further includes receiving, from the wireless communication network, a configured grant for a PUSCH channel, the configured grant indicating the DMRS bundling size. The method also includes transmits on the configured grant on the PUSCH channel, using the indicated PUSCH DMRS bundling.

Aspects of the present approach include a method by a wireless communications network for providing a semi-static indication of demodulation reference signal (DMRS) bundling size to a user equipment (UE), the wireless communication network having a satellite. The method includes indicating, by the wireless communication network, an uplink segmented transmission duration, as well as receiving, by the wireless communication network, a time domain window (TDW) duration capability from the UE. The method further includes scheduling, by the wireless communication network, a configured grant for a PUSCH channel for the UE, the configured grant indicating the DMRS bundling size, wherein the DMRS bundling size is based on the TDW duration capability of the UE and based on the uplink segmented transmission duration. The method also includes performing joint channel estimation based on the actual TDW size for PUSCH DMRS bundling.

Aspects of the present approach includes a user equipment (UE) that includes a radio frequency (RF) transceiver having an antenna, as well as processing circuitry coupled to the RF transceiver. The RF transceiver is configured to receive, from the wireless communication network, an uplink segmented transmission duration for DMRS bundling, and to also transmit, to the wireless communication network, a time domain window (TDW) duration capability. The RF transceiver is also configured to receive, from the wireless communication network, a configured grant for a PUSCH channel, the configured grant indicating the DMRS bundling size. The processing circuitry is configured to cause to transmit on the configured grant on the PUSCH channel, using the indicated PUSCH DMRS bundling.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing DMRS bundling between a user equipment (UE) and satellites in a wireless communication network, according to some aspects of the disclosure.

FIG. 2 illustrates a block diagram of an example system of an electronic device implementing mechanisms for DMRS bundling for communication with satellites, according to some aspects of the disclosure.

FIG. 3 illustrates joint channel estimation using DMRS bundling illustrating an exemplary time domain window (TDW) of slots, in accordance with aspects of the present disclosure.

FIG. 4A illustrates TDW counting based on physical slots, in accordance with aspects of the present disclosure.

FIG. 4B illustrates a consecutive slot sequence 430, in accordance with aspects of the present disclosure.

FIG. 5A and FIG. 5B illustrate the implementation of dynamic indication of DMRS bundling size, in accordance with aspects of the present disclosure.

FIG. 6A and FIG. 6B illustrate indications of the actual TDW size, in accordance with aspects of the present disclosure.

FIG. 7A and FIG. 7B illustrate the semi-static indication of DMRS bundling size, in accordance with aspects of the present disclosure.

FIG. 8 illustrates timing advances in the context, in accordance with aspects of the present disclosure.

FIG. 9 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

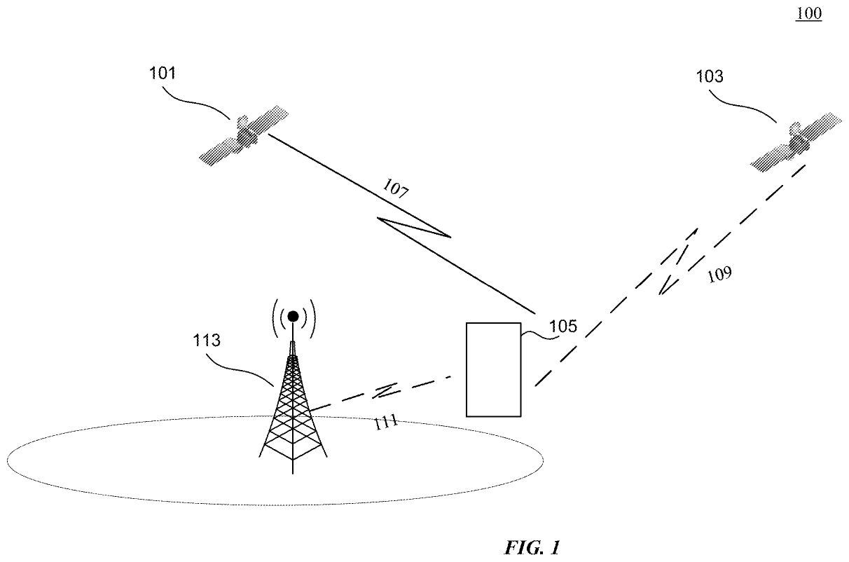

FIG. 1 illustrates an example system implementing mechanisms for DMRS bundling between a user equipment (UE) and non-terrestrial networks, according to some aspects of the disclosure. Example system 100 is provided for the purpose of illustration only and does not limit the disclosed aspects. System 100 may include, but is not limited to, network nodes (base stations that are for example, satellites) 101 and 103 and electronic device (for example, a UE) 105. Electronic device 105 (hereinafter referred to as UE 105) can include an electronic device configured to operate based on a wide variety of wireless communication techniques. These techniques can include, but are not limited to, techniques based on 3rd Generation Partnership Project (3GPP) standards. For example, UE 105 can be configured to operate using the 3GPP standards. UE 105 can include, but is not limited to, as wireless communication devices, smart phones, laptops, desktops, tablets, personal assistants, monitors, televisions, wearable devices, Internet of Things (IoTs), vehicle's communication devices, and the like. Network node 101 (herein referred to as a base station) can include nodes configured to operate based on a wide variety of wireless communication techniques such as, but not limited to, techniques based on 3GPP standards.

According to some aspects, UE 105 and satellites 101 and 103 are configured for radio link monitoring. According to some aspects, UE 105 can be connected to and can be communicating with satellite 101 (e.g., the serving cell) using carrier 107 from which UE 105 receives the multiple downlink signals.

According to some aspects, UE 105 can measure one or more carriers (e.g., carrier 107) used for communication with satellite 101 (e.g., the serving cell) to perform radio link monitoring. UE 105 can measure one or more carriers (e.g., carrier 109) used for communication with satellite 103 (e.g., a neighboring cell) to perform radio link monitoring. UE 105 can measure one or more carriers (e.g., carrier 111) used for communication with terrestrial base station 113 (e.g., nearby terrestrial cell) to perform radio link monitoring.

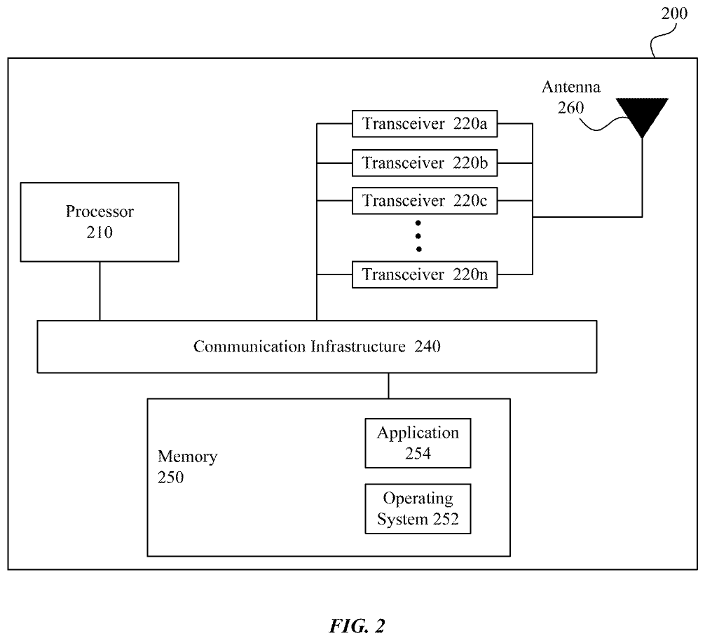

FIG. 2 illustrates a block diagram of an example system 200 of an electronic device implementing mechanisms for DMRS bundling for communication, according to some aspects of the disclosure. System 200 may be any of the electronic devices (e.g., satellites 101, 103, UE 105) of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus.

Processor 210 together with instructions stored in memory 250 performs operations enabling system 200 of system 100 to implement mechanisms for radio link monitoring, as described herein.

One or more transceivers 220a-220n transmit and receive communications signals that support mechanisms for performing time and/or frequency tracking based on those TRS configurations, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a satellite subsystem, cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices. The term “satellite” used here include different types of satellites, such as GEO (geostationary earth orbit) satellites and LEO (low earth orbit) satellites.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, one or more transceivers 220a-220n can be configured to operate according to one or more of Rel-15, Rel-16, Rel-17, or other of the 3GPP standard.

In addition, one or more transceivers 220a-220n can include one or more circuits for connecting to and communicating with satellite networks. Such satellite networks can include, but are not limited to, wireless communication networks such as 3G/4G/5G networks such as Universal Mobile Telecommunications System (UMTS), Long-Term Evolution (LTE), as well as specific satellite communications network protocols for gateway functionality and control functionality from satellite ground stations. For example, one or more transceivers 220a-220n can be configured to operate according to one or more of Rel-15, Rel-16, Rel-17, or other of the 3GPP standard. In addition, for LEO-earth-fixed types of satellites (see below), additional capability is provided to steer beams towards fixed points on the Earth's surface by either beamforming or by a mechanically steerable beam approach.

According to some aspects, processor 210, alone or in combination with computer instructions stored within memory 250, and/or one or more transceiver 220a-220n, implements radio link monitoring, as discussed herein. For example, transceiver 220a can enable connection(s) and communication over a first carrier (for example, carrier 107 of FIG. 1). In this example, transceiver 220a and/or transceiver 220b can enable reception of signaling of TRS configuration information (for example, carrier 109 of FIG. 1). Additionally, or alternatively, wireless system 200 can include one transceiver configured to operate at different carriers. Processor 210 can be configured to control the one transceiver to switch between different carriers, according to some examples. Although the operations discussed herein are discussed with respect to processor 210, it is noted that processor 210, alone or in combination with computer instructions stored within memory 250, and/or one or more transceiver 220a-220n, can implement these operations.

### Overview of Demodulation Reference Signals (DMRS) Approach in a Non-terrestrial Network

In the on-going development of wireless systems, there are on-going needs to expand wireless communication capabilities with a view to greater coverage of such capabilities and increased data rates. Given these needs, satellite networks may be used to supplement terrestrial networks (such as LTE and NR networks) and thereby provide connectivity to remote areas and those areas lacking high data rate services. These services and connectivity include backhaul, transportation, outdoor service, and IoT. In adding these additional capabilities, there are unique challenges to the demodulation reference signals (DRMS) of the connection between a UE and a satellite so that the service is seamless and meets the performance expectations of such a service.

In some aspects, when performing joint channel estimation, there are a number of restrictions that apply, including (a) the modulation order does not change; (b) the resource block (RB) RB allocation in terms of length and frequency position does not change; (c) the transmission power does not change, and (d) the phase continuity between the transmissions is maintained. Various use cases for joint channel estimation may be considered, including the following: (a) back-to-back PUSCH within one slot (PUSCH repetition type B), (b) Back-to-back PUSCH across consecutive slots (PUSCH repetition type A/B, transport block over multi-slot (TBoMS)), and (c) non-back-to-back PUSCH across consecutive slots (PUSCH repetition type A/B, TBoMS), when no other UL transmission in the middle of PUSCH/PUCCH transmissions.

In terms of the time domain window (TDW) considerations for joint channel estimation, the following assumptions apply: (a) the UE is expected to maintain power consistency and phase continuity within the TDW; (b) the maximum duration is set by the UE capability; and (c) for a configured time domain window, the maximum value of window length L of the configured TDW (if configured) should not exceed the maximum duration. If L is not configured, the default value of L is the minimum of the following: the maximum duration, and the set of the duration of all PUSCH repetitions.

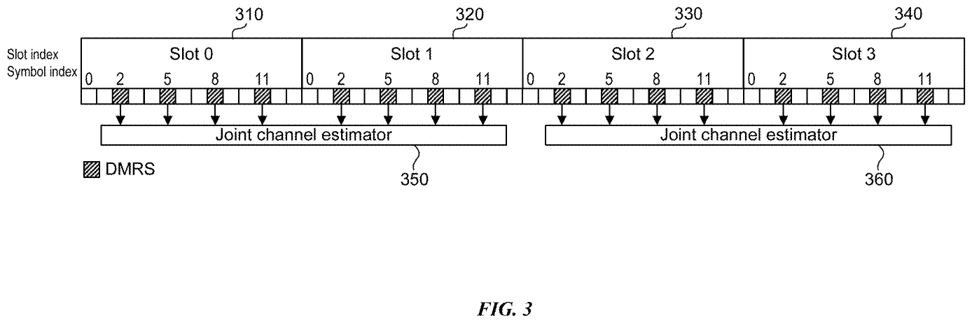

FIG. 3 illustrates joint channel estimation using DMRS bundling illustrating an exemplary time domain window (TDW) of slots, in accordance with aspects of the present disclosure. Four consecutive slots are illustrated, namely slot 0 (310), slot 1 (320), slot 2 (330) and slot 3 (340). Within each of these slots, DRMS signals are transmitted in symbols 2, 5, 8 and 11. The DRMS signals from slot 0 (310) and slot 1 (320) are provided to joint channel estimator 350, while DRMS signals from slot 2 (330) and slot 3 (340) are provided to joint channel estimator 360.

In terms of actual TDWs, within one configured TDW, one or multiple actual TDWs may be implicitly determined. It is noted that if power consistency and phase continuity are violated due to a particular event, the creation of a new actual TDW is subject to the capability of the UE to support the restarting of DMRS bundling. Such events that violate the requirements of power consistency and phase continuity include the following: (a) dropping and/or cancellation based on collision rules set forth in the 3GPP specifications; (b) DL slot or DL reception/monitoring based on semi-static DL/UL configuration for unpaired spectrum; (c) the gap between two PUSCH/PUCCH transmissions exceeds thirteen (13) symbols; (d) for non-back-to-back PUSCH/PUCCH across consecutive slots, the other uplink transmission in in the middle of two PUSCH/PUCCH transmissions; (e) the action of transmit power control (TPC) commands; and (f) UL beam switching for multi-TRP operation, if DMRS bundling and UL beam switching are configured simultaneously.

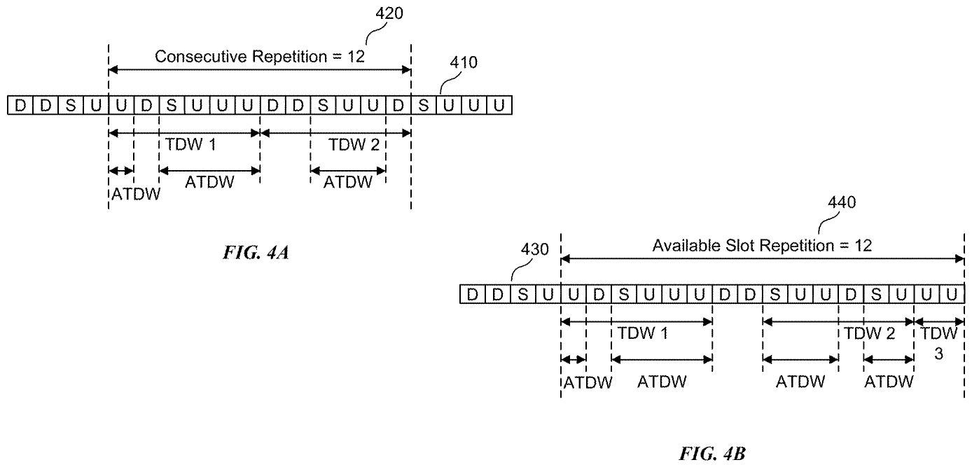

TDW for counting may be based on physical slots or be based on available slots by configuration. FIG. 4A illustrates TDW counting based on physical slots, in accordance with aspects of the present disclosure. FIG. 4A illustrates the consecutive slot sequence 410 having a consecutive repetition of 12 slots 420). Within slots 420, the individual slots are denoted by how each of the symbols within each slot are used. The label “U” indicates that the symbols are used for uplink, the label “D” indicates that the symbols are used for downlink within that specific slot, and the label “S” indicates that the symbols may be used as uplink or downlink. Continuing to refer to FIG. 4A, there are two time domain windows, TDW1 and TDW2 within slots 420, each of which encompasses six slots. For illustration purposes only, six slots are the maximum duration in this illustration. In FIG. 4A, the sequence of slot utilization results in three actual time domain windows (ATDWs). The three ATDWs (counting from left to right) are slot 0, slots 2-5, and 8-10. This is the result of the switching from uplink to downlink utilization, which terminates an ATDW.

FIG. 4B illustrates consecutive slot sequence 430 (same sequence as slot sequence 410 from FIG. 4A), in accordance with aspects of the present disclosure. In FIG. 4B, the available slot repetition is 12, which is the number of slots with symbols available for uplink transmission. Continuing to refer to FIG. 4B, there are three time domain windows, TDW1, TDW2 and TDW3. The actual time domain windows (ATDWs) are shown, with each of the first three ATDWs terminating upon reaching a slot being used for downlink purposes. The final ATDW terminates based on the end of TDW2.

It is noted that the UE should not perform time advance (TA) adjustment during a TDW. If the UE is configured to accumulate TPC commands, then the TPC command takes effect after the current configured TDW. If the UE is not configured to accumulate TPC commands, then the last TPC command takes effect in a configured TDW and supersedes all previous TPC commands taking effect with that configured TDW. In other words, only the last TPC command is applied by UE after the current configured TDW.

Based on the above, the technical challenge is how to enhance the DMRS bundling of PUSCH or PUCCH in a non-terrestrial network. Typically, the timing advance (TA) needs to be fixed in DMRS bundling of PUSCH or PUCCH. However, in a non-terrestrial network, the location of the satellites changes very quickly. Because of this, the TA needs to keep changing. Two solutions are described to meet the challenge described above: (a) a dynamic indication of DMRS bundling size, and (b) a semi-static indication of DMRS bundling size.

### Dynamic Indication of Demodulation Reference Signals (DMRS)

Turning to the first solution (dynamic indication of DMRS bundling size), aspects of this approach are as follows. The steps are described from both the network size and from the UE side. The network indicates the maximum allowed TA variation (TAₜₕᵣₑₛ) for DMRS bundling. It is noted that the network assumes that the TA is not changed for several consecutive slots for the purpose of joint channel estimation. However, as noted above, in the non-terrestrial network scenario, the actual TA keeps changing due to the rapid motion of the satellites. If TA is larger than the required timing error (Te), then the uplink synchronization is broken. The network determines TAₜₕᵣₑₛ for uplink synchronization purposes. The units for TAₜₕᵣₑₛ may be expressed in a number of slots or expressed in absolute time (e.g. milliseconds). TAₜₕᵣₑₛ may be smaller than Te (required timing error).

To effect the dynamic indication of DMRS bundling size, the network signals an indication of the value of TAₜₕᵣₑₛ. There are several alternatives to this signaling. In the first alternative, the indication may be made via either system information block 1 (SIB1), SIB19 or a new NTN-specific SIB. In another alternative, the indication may be provided through a dedicated radio resource control (RRC) message. In a further alternative, the indication may be provided via a medium access control (MAC) control element (CE). In a still further alternative, the indication may be provided via a downlink control information (DCI) signal.

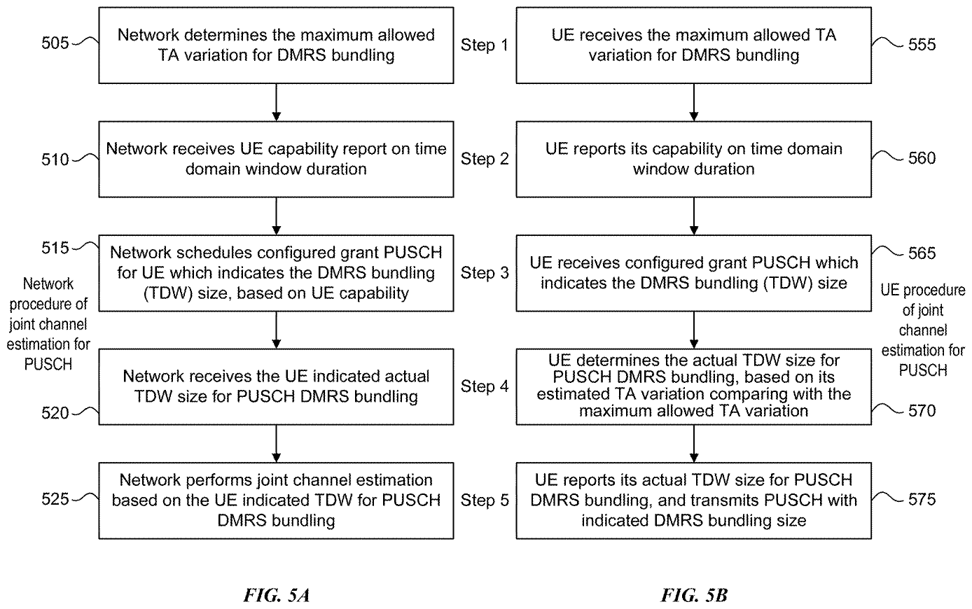

FIG. 5A and FIG. 5B illustrate the first solution, i.e., the dynamic indication of DMRS bundling size, in accordance with aspects of the present disclosure, where FIG. 5A illustrates the solution from the network side, while FIG. 5B illustrates the solution from the UE side. Referring to FIG. 5A, in step 1 (505) the network determines the maximum allowed TA variation for DMRS bundling. This maximum allowed TA variation may depend on elevation angle of the serving beam from the satellite. This maximum allowed TA variation may depend on the speed of the satellite motion, which is related to satellite orbit. In step 2 (510), the network receives a UE capability report on the time domain window (TDW) duration. In step 3 (515), the network schedules configured grant PUSCH for the UE, which indicates the DMRS bundling (TDW) size, based on the capability reported by the UE. For example, a UE reports its capability of a maximum duration for DMRS bundling, which implies the maximum number of slots the UE can keep power consistency and phase continuity. The DMRS bundling (TDW) size in the network scheduled grant PUSCH should not exceed the UE reported maximum duration for DMRS bundling. In step 4 (520), the network receives the UE-indicated actual TDW size for PUSCH DMRS bundling. In step 5 (525), the network performs joint channel estimation based on the UE-indicated TDW for PUSCH DMRS bundling.

Referring to FIG. 5B, in step 1 (555), the UE receives the maximum allowed TA variation for DMRS bundling. In step 2 (560), the UE reports its capability report on the time domain window (TDW) duration. In step 3 (565), the UE receives a configured grant PUSCH, which indicates the DMRS bundling (TDW) size. In step 4 (570), the UE determines the actual TDW size for PUSCH DMRS bundling, based on its estimated TA variation compared with the maximum allowed TA variation. In general, the UE calculates/estimates the TA value of each slot for PUSCH repetitions. If the difference between the TA value of the first slot and the TA value of the X-th slot is larger than TAₜₕᵣₑₛ, but the difference between the TA value of the first slot and the TA value of the (X-1)-th slot is smaller than TAₜₕᵣₑₛ, then the actual TDW size is equal to X. In step 5 (575), the UE reports its actual TDW size for PUSCH DMRS bundling, and transmits using the PUSCH its indicated DMRS bundling size.

As noted in step 4 (520) above, the network receives from the UE, the UE-indicated actual TDW size for PUSCH DMRS bundling. The actual TDW size for PUSCH DMRS bundling may be expressed in units of number of slots or may be expressed in absolute time (e.g., milliseconds). The signaling of the UE indication of actual TDW size may be accomplished using a number of various alternatives. In the first alternative, this indication may be provided via an uplink control information (UCI) signal associated with configured grant PUSCH. In a second alternative, the indication may be provided via a UCI before configured grant. In a further alternative, the indication may be provided using a MAC CE before configured grant. In a still further alternative, the indication may be provided by a dedicated RRC message before configured grant.

In step 4 (570), the UE determines the actual TDW size for PUSCH DMRS bundling based on its estimated TA variation compared with the maximum allowed TA variation. Relevant here is the TA calculation formula, which is T_{TA}=(N_{TA}+N_{TA, UE-specific}+N_{TA, common}+N_{TA,offset})*Tc, where N_{TA} is defined as 0 for PRACH and updated based on TA command field in Msg2/MsgB and MAC CE TA command, N_{TA, UE-specific} is UE self-estimated TA to pre-compensate for the service link delay, N_{TA, common} is network-controlled common TA, and may include any timing offset considered necessary by the network. N_{TA, offset} is a fixed offset used to calculate the timing advance. Based on the TA calculation formula, the UE determines the TA value for each slot in consecutive slots for PUSCH transmissions. The TA calculation is based on both open loop and closed loop TA control. The UE compares the TA value with the maximal allowed TA variation indicated by network. The UE determines the maximum number of slots with TA variation being within the maximal allowed TA variation.

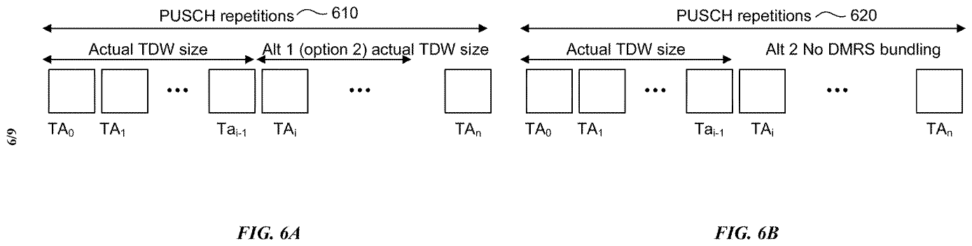

In step 5, the UE reports its actual TDW size for PUSCH DMRS bundling, and transmits the PUSCH signal with its indicated DMRS bundling size. There are three alternatives. In the first alternative, the DMRS bundling can continue after the segmented uplink slots. Two options are possible for this first alternative. The first option is that the next actual TDW size(s) for the following PUSCH DMRS bundling may be additionally indicated. In a second option, the same actual TDW size is applied for the following PUSCH DMRS bundling. FIG. 6A illustrates this alternative, whereby the difference of TAᵢ₋₁ and TA₀ is less than the TAₜₕᵣₑₛ (the threshold value), while the difference of TAᵢ and TA₀ is more than the TAₜₕᵣₑₛ. Accordingly, the actual TDW size is equal to i.

In a second alternative, DMRS bundling is stopped after the segmented uplink slots. As such, all the following slots in PUSCH does not apply DMRS bundling. In a third alternative, the UE stops the PUSCH transmission after the actual TDW size. In this alternative, the UE does not report its actual TDW size, since it implicitly indicates the actual TDW size. FIG. 6B illustrates this alternative, whereby the difference of TAᵢ₋₁ and TA₀ is less than the TAₜₕᵣₑₛ (the threshold value), while the difference of TAᵢ and TA₀ is more than the TAₜₕᵣₑₛ. Accordingly, the actual TDW size is equal to i.

In certain scenarios, it is noted that an additional gap may be added between the two actual TDW transmissions to address the TA adjustment. The units of this additional gap may be in samples, symbols or slots. The gap may also be counted as a part of the later slot, i.e., the later slot will be impacted by the size of the gap.

### Semi-Static Indication of Demodulation Reference Signals (DMRS)

Turning to the second solution (semi-static indication of DMRS bundling size), aspects of this approach to the joint channel estimation for PUSCH in non-terrestrial networks is as follows. The same applies to both PUSCH and PUCCH, and descriptions are provided for both the network side and the UE side.

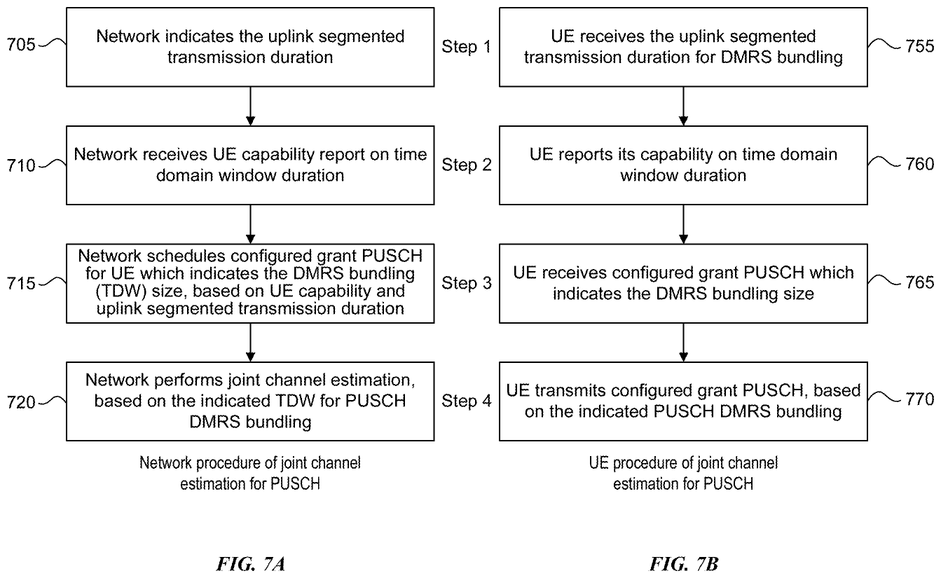

FIG. 7A and FIG. 7B illustrate the second solution, i.e., the semi-static indication of DMRS bundling size, in accordance with aspects of the disclosure, where FIG. 7A illustrates the solution from the network side, while FIG. 7B illustrates the solution from the UE side. Referring to FIG. 7A, in step 1 (705) the network indicates the uplink segmented transmission duration. In step 2 (710), the network receives a UE capability report on the maximum time domain window (TDW) duration. In step 3 (715), the network schedules configured grant PUSCH for the UE, which indicates the DMRS bundling (TDW) size, based on the capability reported by the UE and the uplink segmented transmission duration. In step 4 (720), the network performs joint channel estimation based on the UE-indicated TDW for PUSCH DMRS bundling.

Referring to FIG. 7B, in step 1 (755), the UE receives the uplink segment duration for DMRS bundling. In step 2 (760), the UE reports its capability report on the maximum time domain window (TDW) duration. In step 3 (765), the UE receives a configured grant PUSCH, which indicates the DMRS bundling size. In step 4 (770), the UE transmits on the configured grant PUSCH, based on the indicated PUSCH DMRS bundling size.

As noted above in step 1 (705), the network indicates the uplink segmented transmission duration. Here, it is assumed that the TA and the frequency offset remain the same for the uplink segmented transmissions. The uplink segmented transmission duration may depend on elevation angle between the satellite and the UE. For a large elevation angle, the uplink segmented transmission is smaller since the TA variation is smaller. For a small elevation angle, the uplink segmented transmission is larger since the TA variation is larger. It is possible that multiple uplink segmented transmission durations are indicated, whereby the use of which duration depends on the elevation angle of the UE. The elevation angle may be informed by the UE to the network. The uplink segmented transmission duration may depend on K_{offset} value, whereby the K_{offset} value is an offset value known to both network and UE. This value is used to determine the uplink transmission slot. It is generally larger than the TA (timing advance) so that the uplink transmission scheduling is causal. The K_{offset} value may be either a cell-specific K_{offset} or a UE-specific K_{offset} value. For a larger K_{offset} value, the uplink segmented transmission duration is larger. For a smaller K_{offset} value, the uplink segmented transmission duration is smaller. It is possible that multiple uplink segmented transmission durations are indicated, whereby the use of which duration depends on the K_{offset} value.

The signaling of the uplink segmented transmission duration may be undertaken with one or more of the following alternatives. In the first alternative, the indication may be made via either system information block 1 (SIB1), SIB19 or a new NTN-specific SIB. In another alternative, the indication may be provided through a dedicated radio resource control (RRC) message. In a further alternative, the indication may be provided via a medium access control (MAC) control element (CE). In a still further alternative, the indication may be provided via a downlink control information (DCI) signal. Note that the signaling of the uplink segmented transmission duration may be part of the configuration for PUSCH DMRS bundling (i.e., it may be signaled as part of DMRS-BundlingPUSCH-Config) or it may be independently configured from USCH DMRS bundling. The unit of uplink segmented transmission duration may be slots.

In this second solution, step 1 and step 2 may be swapped. After receiving the reported max duration, then the base station (e.g., gNB) determines the size of segment to make sure that the TA will not change within a TDW.

In step 3 (715), the network schedules a configured grant PUSCH for UE, which indicates the DMRS bundling size. This size is based on UE capability and uplink segmented transmission duration. This approach may be extended to a dynamic grant PUSCH as well, with at least two options. In a first option, the minimum value of the UE-reported DMRS bundling size and the uplink segmented transmission duration are taken as the dedicated DMRS bundling size value for the UE. In a second option, if the TDW is configured, the TDW size is additionally upper-bounded by the uplink segmented transmission duration. If the TDW is not configured, then the TDW size is equal to a minimum value of: (a) the UE-reported maximum duration of the DMRS bundling size; (b) the PUSCH repetition size; (c) the frequency hopping interval for PUSCH repetitions; and (d) the uplink segmented transmission duration. There are two alternatives for the indication of DMRS bundling size. In the first alternative, a new information element (IE): “DMRS-BundlingPUSCH-Config_NTN” is designed, which has a different time domain window length from the legacy IE “DMRS-BundlingPUSCH-Config-r17.” In another alternative, a new element of “pusch-TimeDomainWindowLength-NTN” is added to the existing IE of “DMRS-BundlingPUSCH-Config-r17” whose value is not larger than the UE-reported DMRS bundling size and uplink segmented transmission duration.

In the signaling, the segment is equal to or smaller than the UE-reported maximum duration. The size of the segment is the same as the TDW. The TA command is applied to the first transmission of a segment, and keeps the same TA within the slot of segment. The new TA is applied to the next segment.

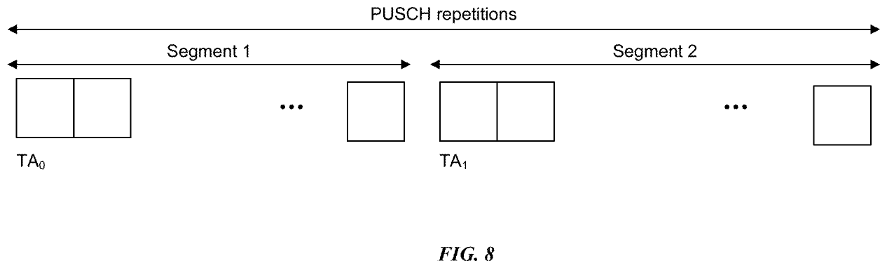

FIG. 8 illustrates timing advances in the context, in accordance with aspects of the present disclosure. Segment 1 uses timing advice TA₀, while segment 2 uses timing advice TA₁.

### Exemplary Computer System

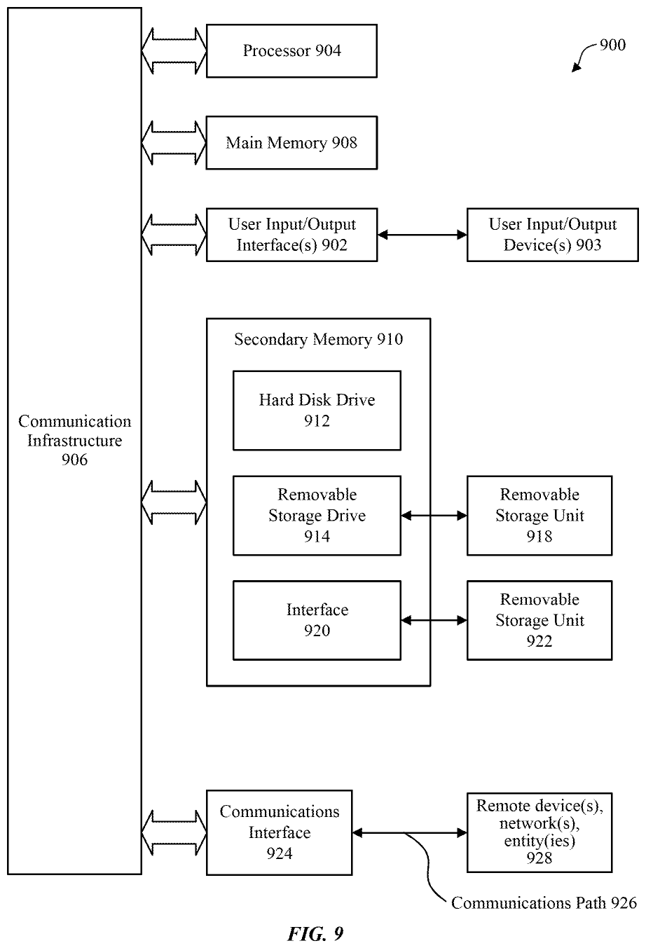

Various aspects can be implemented, for example, using one or more computer systems, such as computer system 900 shown in FIG. 9. Computer system 900 can be any well-known computer capable of performing the functions described herein such as devices 101, 103, 105 of FIG. 1, or 200 of FIG. 2. Computer system 900 includes one or more processors (also called central processing units, or CPUs), such as a processor 904. Processor 904 is connected to a communication infrastructure 906 (e.g., a bus.) Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 may include one or more levels of cache. Main memory 908 has stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to some aspects, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and may include any combination of LANs, WANs, the Internet, etc. Control logic and/or data may be transmitted to and from computer system 900 via communication path 926.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 9. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “an aspect,” “an example aspect,” or similar phrases, indicate that the aspect described may include a particular feature, structure, or characteristic, but every aspects may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. The breadth and scope of the disclosure should not be limited by any of the above-described exemplary aspects, but should be defined only in accordance with the following claims and their equivalents.

As described above, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates aspects in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed aspects, the present disclosure also contemplates that the various aspects can also be implemented without the need for accessing such personal information data. That is, the various aspects of the present technology are not rendered inoperable due to the lack of all or a portion of such personal information data.

1. A method by a user equipment (UE) for providing a dynamic indication of demodulation reference signal (DMRS) bundling size in a wireless communication network having a satellite, the method comprising:
receiving, from the wireless communication network, a maximum allowed timing advance (TA) variation for DMRS bundling;
reporting, to the wireless communication network, a time domain window (TDW) duration capability;
receiving, from the wireless communication network, a configured grant for a PUSCH channel, the configured grant indicating the DMRS bundling size;
determining an actual TDW size for physical uplink shared channel (PUSCH) DMRS bundling based on an estimated TA variation compared with the maximum allowed TA variation; and
reporting, to the wireless communication network, the actual TDW size for PUSCH DMRS bundling using the PUSCH channel.

2. The method of claim 1, wherein the receiving the maximum allowed TA includes receiving an indication of the maximum allowed TA variation via a system information block 1 (SIB1), SIB19 or an NTN-specific SIB.

3. The method of claim 1, wherein the receiving the maximum allowed TA variation includes receiving an indication of the maximum allowed TA variation via a dedicated radio resource control (RRC) message, a medium access control (MAC) control element (CE), or a downlink control information (DCI) signal.

4. The method of claim 1, wherein the reporting the actual TDW size includes reporting an indication of the actual TDW size via an uplink control information (UCI) signal associated with configured grant PUSCH, a UCI before a configured grant, a MAC CE before the configured grant, or a dedicated RRC message before the configured grant.

5. The method of claim 1, wherein the DMRS bundling continues after segmented uplink slots, wherein a next actual TDW size for a following PUSCH DMRS bundling is indicated.

6. The method of claim 1, wherein the DMRS bundling continues after segmented uplink slots, wherein a same actual TDW size is applied for the following PUSCH DMRS bundling.

7. The method of claim 1, wherein the DMRS bundling stops after segmented uplink slots or wherein the DMRS bundling stops after an actual TDW size.

8. The method of claim 1, further comprising adding a gap between two actual TDW transmissions to address a TA adjustment, the gap being indicated in units of samples, symbols or slots.

9. The method of claim 1, further comprising adding a gap between two actual TDW transmissions to address a TA adjustment, wherein the gap is counted as a part of a later slot.

10. The method of claim 1, further comprising:
determining an actual TDW size for physical uplink control channel (PUCCH) DMRS bundling based on an estimated TA variation compared with the maximum allowed TA variation; and
reporting, to the wireless communication network, the actual TDW size for PUCCH DMRS bundling using the PUCCH channel.

11. (canceled)

12. A user equipment (UE) comprising:
a radio frequency (RF) transceiver configured to, via an antenna:
receive, from the wireless communication network, a maximum allowed timing advance (TA) variation for DMRS bundling;
transmit, to the wireless communication network, a time domain window (TDW) duration capability;
receive, from the wireless communication network, a configured grant for a physical uplink shared channel (PUSCH), the configured grant indicating the DMRS bundling size;
processing circuitry coupled to the RF transceiver, the processing circuitry configured to:
determine an actual TDW size for PUSCH DMRS bundling based on an estimated TA variation compared with the maximum allowed TA variation; and
the radio frequency (RF) transceiver further configured to report, via the antenna to the wireless communication network, the actual TDW size for PUSCH DMRS bundling using the PUSCH channel.

13. A method by a user equipment (UE) for providing a semi-static indication of demodulation reference signal (DMRS) bundling size in a wireless communication network having a satellite, the method comprising:
receiving, from the wireless communication network, an uplink segmented transmission duration for DMRS bundling;
reporting, to the wireless communication network, a time domain window (TDW) duration capability;
receiving, from the wireless communication network, a configured grant for a physical uplink shared channel (PUSCH), the configured grant indicating the DMRS bundling size; and
transmitting on the configured grant on the PUSCH channel, using the indicated PUSCH DMRS bundling.

14. The method of claim 13, wherein the receiving the uplink segmented transmission duration includes receiving an indication of the maximum uplink segmented transmission duration via a system information block 1 (SIB1), SIB19 or an NTN-specific SIB.

15. The method of claim 13, wherein the receiving the uplink segmented transmission duration includes receiving an indication of the maximum uplink segmented transmission duration via a dedicated radio resource control (RRC) message.

16. The method of claim 13, wherein the receiving the uplink segmented transmission duration includes receiving an indication of the maximum uplink segmented transmission duration via a medium access control (MAC) control element (CE).

17. The method of claim 13, wherein the receiving the uplink segmented transmission duration includes receiving an indication of the maximum uplink segmented transmission duration via a downlink control information (DCI) signal, wherein the indication is a part of a PUSCH DMRS bundling configuration, or the indication is independently configured from the PUSCH DMRS bundling configuration.

18. The method of claim 13, wherein the DMRS bundling size is a minimum value of a reported DMRS bundling size and an uplink segmented transmission duration.

19. The method of claim 13, wherein if a TDW is configured, a size of the TDW is additionally upper bounded by uplink segmented transmission duration, or wherein if a size of the TDW is not configured, the size of the TDW is set equal to a minimum value of the UE-reported maximum duration of the DMRS bundling size, the PUSCH repetition size, the frequency hopping interval for PUSCH repetitions, and the uplink segmented transmission duration.

20. The method of claim 13, wherein the DMRS bundling size is reported as an information element (IE) having a different time domain window length from prior versions of the IE.

21. (canceled)

22. (canceled)

23. The method of claim 13, wherein a TA command is applied to a first transmission of a segment, wherein a same TA is applied within a slot of the segment, and wherein a new TA is applied to a next segment.

24. (canceled)

25. (canceled)
